(19) United States
(12) Patent Application Publication
(10) Pub. No.: US 2003/0141790 A1
(43) Pub. Date: Jul. 31, 2003

(54) Internal locking device for drawer slide rail

(76) Inventor: Kuo-Chan Weng, Yun Lin Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/145,024

(22) Filed: May 15, 2002

(30) Foreign Application Priority Data
Jan. 31, 2002 (TW) 091201197

(51) Int. Cl. E05B 65/46

(52) U.S. Cl. 312/217

(57) ABSTRACT

Internal locking device for drawer slide rail, including a first and a second slide rail assemblies and a first activator, a second activator and a shaft rod. Each of the first and second slide rail assemblies includes a stationary slide rail and a set of extensible slide rail. The first activator is disposed at front end of the extensible slide rail. The second activator includes a pair of base seats and a pair of transmission members. The base seats are vertically slidably disposed at front end of the stationary slide rail. The transmission members are correspondingly pivotally disposed on the stationary slide rail and positioned on the base seats. The shaft rod is disposed between the first and second slide rail assemblies with two ends respectively connected with the base seats of the first and second slide rail assemblies. When the extensible slide rail of the first slide rail assembly is extended from the stationary slide rail, the first activator turns the transmission members to push and lock the base seats. At this time, the extensible slide rail of the second slide rail assembly is prevented from being extended out from the stationary slide rail.

### BACKGROUND OF THE INVENTION

The present invention is related to a locking device for drawer slide rail, and more particularly to an internal locking device for drawer slide rail of a tool cabinet or file cabinet having several drawers.

A drawer and a cabinet are equipped with corresponding rails. The rails are slidably fitted with each other for easily pushing or drawing the drawer within the cabinet. The rails are provided with stoppers such as projecting blocks or projecting plates to prevent the drawer from detaching from the cabinet and dropping.

The drawer is often designed with a considerable length for receiving more articles. In order to fully draw the drawer out of the cabinet without being derailed and immediately push the drawer into the cabinet after taking articles, three rails are provided, including a cabinet slide rail, a middle slide rail and a drawer slide rail. Each slide rail has stop blocks on predetermined portions of one end or two ends of the slide rail. The slide rails are slidably assembled with each other and the stop blocks stop each other, whereby the drawer can be fully drawn out of the cabinet without derailing and dropping. Ball bearings are provided between the slide rails to reduce frictional force therebetween and noise.

The tool cabinet or file cabinet includes several drawers arranged from upper side to lower side. After the drawers contain tools or files, the drawers will have considerable weight. In the case that the drawers are drawn too hard or in the case of earthquake or collision by external force, the tool cabinet or file cabinet will be tilted to make some drawers slip out. Under such circumstance, the gravity center of the cabinet will change and the cabinet may fall down.

In order to avoid tilting down of the cabinet when drawing out too many drawers, a slide rail locking structure has been developed by which only one drawer can be drawn at one time. Substantially, a linking unit is disposed at one end of each slide rail assembly. Once the drawer slide rail of one slide rail assembly is pulled, the linking unit is activated to drive a link disposed between the respective slide rail assemblies to stop the drawer slide rails of other slider rail assemblies from being pulled. For example, in U.S. Pat. No. 5,352,030, a disc-like activating block is disposed at rear end of the drawer slide rail. In U.S. Pat. No. 5,634,701, an activating block having a slope is disposed at front end of one side of the drawer. In U.S. Pat. No. 5,988,778, an activating block is disposed at front end of the drawer slide rail.

In U.S. Pat. No. 5,352,030, a hook body is disposed at rear end of the drawer slide rail for hooking and pulling the disc-like activating block. This is strength-consuming and the components are likely to be worn. Therefore, the using life of the product is shortened.

### SUMMARY OF THE INVENTION

It is therefore a primary object of the present invention to provide an internal locking device for drawer slide rail, which enables a user to smoothly push and draw a drawer and prolongs using life of the slide rail.

It is a further object of the present invention to provide the above internal locking device for drawer slide rail, which in narrow space of the slide rail assembly, is able to truly lock the slide rail. After one of the drawers is drawn, the other drawers are prevented from being drawn out.

According to the above objects, the internal locking device for drawer slide rail, including a first and a second slide rail assemblies and a first activator, a second activator and a shaft rod. Each of the first and second slide rail assemblies includes a stationary slide rail and a set of extensible slide rail. The first activator is disposed at front end of the extensible slide rail. The second activator includes a pair of base seats and a pair of transmission members. The base seats are vertically slidably disposed at front end of the stationary slide rail. The transmission members are correspondingly pivotally disposed on the stationary slide rail and positioned on the base seats. The shaft rod is disposed between the first and second slide rail assemblies with two ends respectively connected with the base seats of the first and second slide rail assemblies.

The present invention can be best understood through the following description and accompanying drawings wherein:

### BRIEF DESCRIPTION OF THE DRAWINGS

FIG. 1 is a perspective exploded view of a preferred embodiment of the present invention;

FIGS. 2 and 3 are front views of two aspects of the transmission members of the present invention; and

FIGS. 4 and 5 show the continuous operation of the present invention.

### DETAILED DESCRIPTION OF THE PREFERRED EMBODIMENTS

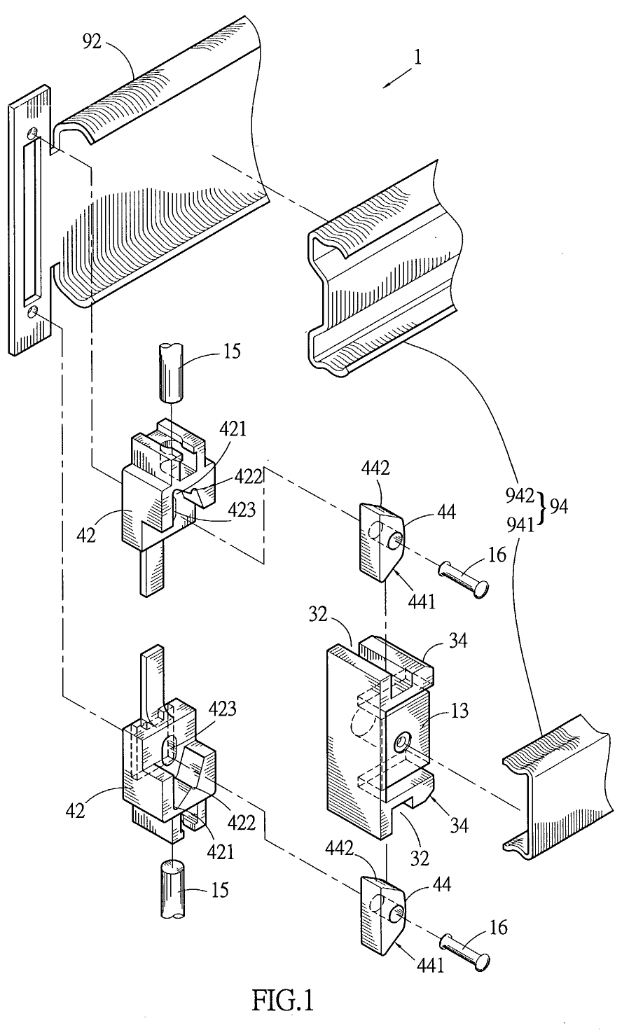

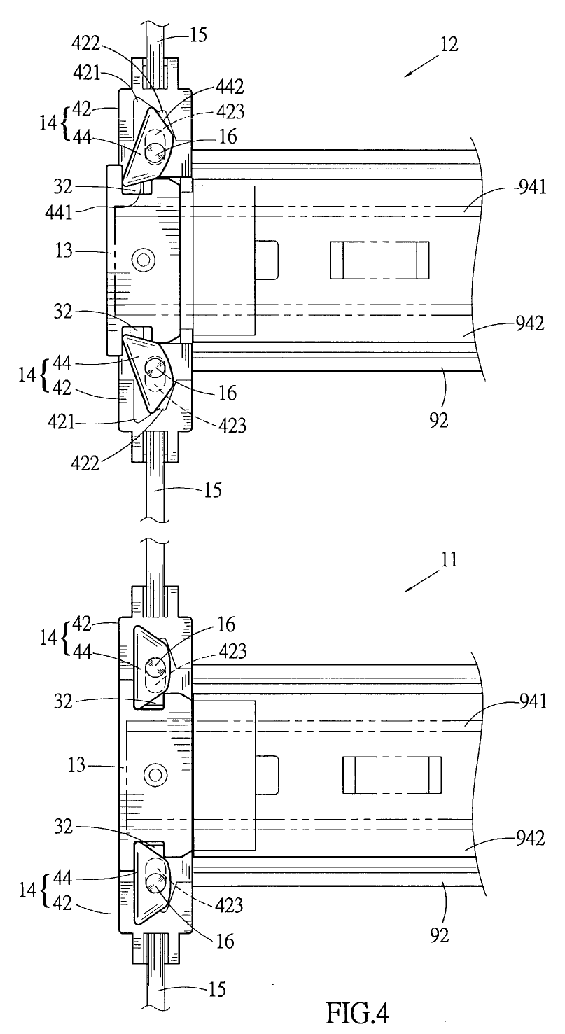

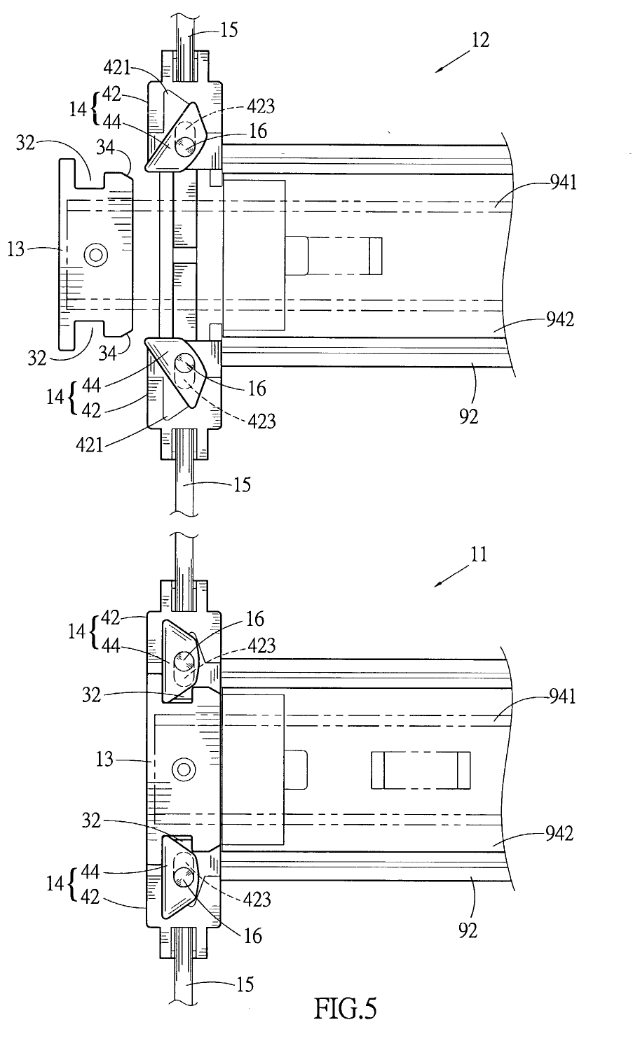

Please refer to FIGS. 1 to 5. The internal locking device 1 for drawer slide rail of the present invention includes a first slide rail assembly 11, a second slide rail assembly 12 and a first activator 13, a second activator 14 and a shaft rod 15 disposed on the first and second slide rail assemblies 11, 12.

The second slide rail assembly 12 corresponds to the first slide rail assembly 11 and is positioned above the first slide rail assembly 11. The first and second slide rail assemblies 11, 12 respectively include a stationary slide rail 92 and a set of extensible slide rail 94.

The stationary slide rail 92 is a channel body having a bottom wall and two lateral walls. The outer side of the bottom wall is fixed on a cabinet body having at least two vertically arranged drawers.

Each extensible slide rail 94 is composed of a drawer slide rail 941 and a middle slide rail 942. Each of the drawer slide rail 941 and middle slide rail 942 is a channel body having a bottom wall and two lateral walls. The outer side of the bottom wall is fixed on the drawer. The two lateral walls are slidably disposed in the middle slide rail 942. The middle slide rail 942 is slidably disposed in the stationary slide rail 92 and extensible from the front end of the stationary slide rail 92.

The first activator 13 is a block body disposed at front end of the drawer slide rail 941. The upper and lower sides of the first activator 13 are respectively formed with two notch-like first connecting sections 32.

The second activator 14 includes a pair of base seats 42 and a pair of transmission members 44.

The base seats 42 are spaced from each other by a certain distance. The base seats 42 are correspondingly and vertically slidably disposed at front end of the stationary slide rail 92. Each base seat 42 is formed with a notch-like second connecting section 421 and a notch-like stop section 422 adjacent to the second connecting section 421. The second connecting section 421 corresponds to the first connecting section 32.

The transmission members 44 are polygonal block bodies. The transmission members 44 via pivot shafts 16 are correspondingly pivotally disposed on the stationary slide rail 92. Each pivot shaft 16 is passed through a slot 423 formed on the base seat 42, whereby the transmission member 44 is positioned on the base seat 42 between the first and second connecting sections 32, 421. The transmission member 44 is formed with a third and a fourth connecting sections 441, 442 corresponding to the first and second connecting sections 32, 421. When the drawer slide rail 941 is not extended, the third and fourth connecting sections 441, 442 of the transmission member 44 are respectively engaged with the first and second connecting sections 32, 421. When one drawer slide rail 941 is extended, the first activator 13 turns the transmission members 44 to further push the base seats 42. Thereafter, the fourth connecting sections 442 of the transmission members 44 are engaged with the stop sections 422 to stop the base seats 42 from sliding.

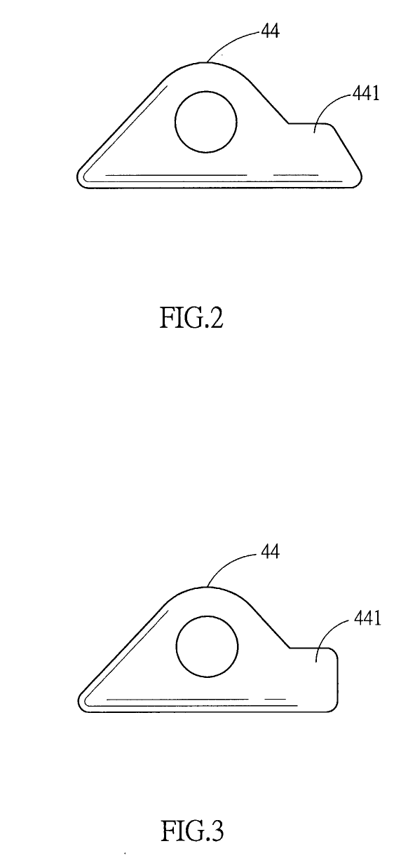

The fourth connecting section 442 of the transmission member 44 is a projecting section having a slope. The second connecting section 421 is formed with a slope corresponding to the slope of the fourth connecting section 442. The third connecting section 441 of the transmission member 44 can be also a projecting section having a slope or free from any slope (as shown in FIGS. 2 and 3).

The shaft rod 15 is disposed between the first and second slide rail assemblies 11, 12. Two ends of the shaft rod 15 are respectively connected with the base seats 42 of the first and second slide rail assemblies 11, 12.

According to the above arrangement, when the extensible slide rail 94 of the second slide rail assembly 12 is extended from the front end of the stationary slide rail 92, the first connecting section 32 of the first activator 13 turns the transmission member 44. Via the second and fourth connecting sections 421, 442, the transmission member 44 pushes the base seat 42. Then, by means of the engagement between the stop section 422 and the fourth connecting section 442, the transmission member 44 locks the base seat 42. Accordingly, the extensible slide rail 94 of the first slide rail assembly 11 is prevented from being extended from the front end of the stationary slide rail 92.

After the extensible slide rail 94 of the second slide rail assembly 12 is pushed into the stationary slide rail 92, the first connecting section 32 of the first activator 13 turns the transmission member 44, whereby the stop section 422 and the fourth connecting section 442 are no more engaged with each other so that the base seat 42 is unlocked from the transmission member 44. Under such circumstance, the extensible slide rail 94 of the first slide rail assembly 11 can be extended from the front end of the stationary slide rail 92.

In the above embodiment, the upper and lower sides of the first activator 13 are formed with guide slopes 34, whereby the extensible slide rail 94 can be smoothly pushed inward to turn the transmission member 44.

The present invention has the following advantages:

1. The transmission member 44 is such engaged with the first connecting section 32 of the first activator 13 and the second connecting section 421 of the base seat 42 that the base seat 42 can be truly pushed.

2. The stop section 422 is engaged with the transmission member 44 to truly lock other drawers.

In another embodiment of the present invention, the pivoted portion of the transmission member 44 is such designed that when the extensible slide rail 94 is extended from the front end of the stationary slide rail 92 to completely turn the transmission member 44, the abutting point of the transmission member 44 against the base seat 42 is over the connecting line of the pivot centers of the respective transmission members 44. Therefore, the stop section 422 is omitted. Instead, the transmission member 44 abuts against an extending wall face of the notch-like second connecting section 421 to achieve a locking effect.

In still another embodiment of the present invention, the extensible slide rail 94 can simply have a drawer slide rail 941. Two lateral walls of the drawer slide rail 941 are slidably disposed in the stationary slide rail 92 to achieve the same function as the above embodiment.

The above embodiments are only used to illustrate the present invention, not intended to limit the scope thereof. Many modifications of the above embodiments can be made without departing from the spirit of the present invention.

What is claimed is:

1. Internal locking device for drawer slide rail, when a drawer is drawn out, said locking device preventing other drawers from being drawn out, said locking device comprising:
a first slide rail assembly and a second slide rail assembly, the second slide rail assembly corresponding to the first slide rail assembly and being parallelly positioned above the first slide rail assembly, the first and second slide rail assemblies respectively including a stationary slide rail and a set of extensible slide rail, the stationary slide rail being a channel body having a bottom wall and two lateral walls, the stationary slide rail being fixed on a cabinet body having at least two vertically arranged drawers, each extensible slide rail including a drawer slide rail which is a channel body having a bottom wall and two lateral walls, the drawer slide rail being fixed on a drawer, the drawer slide rail being slidably disposed in the stationary slide rail and extensible from a front end of the stationary slide rail; and
a first activator, a second activator and a shaft rod disposed on the first and second slide rail assemblies, the first activator being disposed at front end of the drawer slide rail, the second activator including a pair of base seats and a pair of transmission members, the base seats being spaced from each other by a certain distance, the base seats being correspondingly and vertically slidably disposed at front end of the stationary slide rail, the transmission members being correspondingly pivotally disposed on the stationary slide rail and respectively positioned on the base seats, whereby when one drawer slide rail is extended, the first activator turns the transmission members to further push the base seats, thereafter, the transmission members being engaged with the base seats to stop the base seats from sliding, the shaft rod being disposed between the first and second slide rail assemblies, two ends of the shaft rod being respectively connected with the base seats of the first and second slide rail assemblies.

2. Internal locking device for drawer slide rail as claimed in claim 1, wherein:
the upper and lower sides of the first activator are respectively formed with two first connecting sections;
each base seat is formed with a second connecting section corresponding to the first connecting section;
the transmission members are positioned between the first and second connecting sections, each transmission member being formed with a third and a fourth connecting sections corresponding to the first and second connecting sections, whereby when the drawer slide rail is not extended, the third and fourth connecting sections of the transmission member are respectively engaged with the first and second connecting sections.

3. Internal locking device for drawer slide rail as claimed in claim 2, wherein the first connecting section is a notch and the third connecting section is a projecting section.

4. Internal locking device for drawer slide rail as claimed in claim 2, wherein the first connecting section is a notch and the third connecting section is a projecting section having a slope.

5. Internal locking device for drawer slide rail as claimed in claim 2 wherein the fourth connecting section is a projecting section having a slope and the second connecting section has a slope corresponding to the slope of the fourth connecting section.

6. Internal locking device for drawer slide rail as claimed in claim 2, wherein the base seat is further formed with a stop section for engaging with the fourth connecting section of the transmission member so as to truly stop the base seat from sliding.

7. Internal locking device for drawer slide rail as claimed in claim 6, wherein the stop section is a notch adjacent to the second connecting section.

8. Internal locking device for drawer slide rail as claimed in claim 1, wherein the extensible slide rail further includes a middle slide rail which is a channel body having a bottom wall and two lateral walls, the two lateral walls of the drawer slide rail being slidably disposed in the middle slide rail, the middle slide rail being slidably disposed in the stationary slide rail and extensible out from the front end of the stationary slide rail.

9. Internal locking device for drawer slide rail as claimed in claim 1, wherein the upper and lower sides of the first activator are formed with guide slopes, whereby the drawer slide rail can be smoothly pushed inward to turn the transmission members.
